(19) United States
(12) Patent Application Publication
(10) Pub. No.: US 2026/0087848 A1
(43) Pub. Date: Mar. 26, 2026

(54) METHOD FOR PROCESSING IMAGES IN A MOTOR VEHICLE

(71) Applicant: Continental Automotive Technologies GmbH, Hannover (DE)

(72) Inventors: Thomas MENEYROL, Toulouse (FR); Farhood NEGIN, Toulouse (FR)

(73) Assignee: Continental Automotive Technologies GmbH, Hannover (DE)

(21) Appl. No.: 19/335,535

(22) Filed: Sep. 22, 2025

(30) Foreign Application Priority Data
Sep. 23, 2024 (FR) FR2410113

(51) Int. Cl. G06V 40/16; G06T 17/00; G06T 19/20; G06V 10/25; G06V 40/10

(52) U.S. Cl. CPC G06V 40/172; G06T 17/00; G06T 19/20; G06V 10/25; G06V 40/103; G06V 40/161

(57) ABSTRACT

The invention relates to a method for authenticating or identifying a person using a camera (10), comprising the steps of generating a sequence of images with the camera (10), and for each image of said sequence of images, detecting (E1) at least one person in said image, defining (E2), in the image, at least one region called the “region of interest” for each detected person or group of detected persons, and for each identified region of interest, rectifying (E3) the region of interest, detecting (E4) the face of at least one person in the rectified region of interest, generating (E5) a 3D model representing each detected face, and rotating (E6) each generated 3D model so that said face is visible straight on in the acquisition plane of the camera, then authenticating or identifying (E7) the at least one person based on the at least one face having undergone rotation.

### CROSS REFERENCE TO RELATED APPLICATIONS

This application claims priority to French Application No. 2410113, filed Sep. 23, 2024, the contents of such application being incorporated by reference herein.

### FIELD OF THE INVENTION

The present invention relates to the field of authentication and identification and more particularly relates to a method for processing images generated by a camera in order to identify or authenticate a person, in particular intended for use in a motor vehicle.

### BACKGROUND OF THE INVENTION

Nowadays, it is known to use embedded cameras to assist the driver of a vehicle with driving, with reversing of the vehicle for example, a camera being placed at the rear of the vehicle (trunk lid or rear bumper) to this end, or to allow a user of the vehicle access to the passenger compartment. In the latter case, the camera is mounted on or near the driver-side door.

In order to allow a wide-angle view to be achieved with an embedded camera of small size, in vehicles, it is common for so-called “fish-eye” cameras that have a 360° blind-spot-free field of view to be used, in particular to authenticate or identify a user of the vehicle in order to permit her or him to access the passenger compartment. Authentication consists in determining whether the face of a person featuring in the images is a real face or a fake face, for example one printed on a medium, whereas identification consists in comparing the face of a person featuring in the images with the images of faces stored in a memory region, with a view to determining the identity of the person.

With this type of fish-eye camera and in the absence of specific processing, the 360° images appear distorted. It is known to pre-process the images before analyzing them to detect a face with the aim of authenticating or identifying it.

In existing solutions, this pre-processing consists in a rectification of the images generated by the fish-eye camera, which are then processed to detect a face.

However, it has been noted that defects such as occlusion and/or distortion may occur with these existing methods, this potentially leading to failure of authentication or identification.

Likewise, with existing methods, variable lighting conditions may reduce the accuracy or sharpness of the images, this again potentially leading to failure of authentication or identification and/or increased vulnerability to spoofing attacks or identity theft, using 3D masks for example, which represents a risk to the security of the vehicle.

Lastly, existing methods may decrease authentication or identification performance because they are insufficiently robust to handle variability in the pose, appearance and expression of faces, this also representing a drawback in terms of security.

A simple, reliable and efficient solution allowing these drawbacks to be at least partly overcome would therefore be advantageous.

### SUMMARY OF THE INVENTION

To this end, a first subject of the invention is a method for authenticating or identifying a person using a camera configured to generate two-dimensional images in an acquisition plane, said method comprising the steps of:
generating a sequence of images with the camera,
for each image of said sequence of images:
detecting at least one person in said image,
defining, in the image, at least one region called the “region of interest” for each detected person or group of detected persons,
for each identified region of interest:
rectifying the region of interest,
detecting the face of at least one person in the rectified region of interest,
generating (a.k. a. reconstruction) a 3D model representing each detected face,
rotating each generated 3D model so that said face is visible straight on in the acquisition plane of the camera,
authenticating or identifying the at least one person based on the at least one face having undergone rotation.

The method according to an aspect of the invention makes it easier to authenticate or identify an authorized user because it is based on a 3D face model that is produced in a rectified region of interest of the image, and that is rotated so as to make it as though it were facing the camera, this improving the quality of the authentication or identification. The method according to an aspect of the invention in particular makes it possible to provide a better input image to face identification algorithms (by virtue of the enhancement of the input pixels achieved through the rectification and construction of 3D face models), to attenuate the impact of distortion on the accuracy of the identification algorithms, to increase the security of access systems by preventing spoofing attacks or identity theft and to improve the overall performance of facial identification algorithms in advanced driver-assistance systems where system efficiency is crucial.

Preferably, the method is implemented by an electronic control unit of a motor vehicle, the at least one camera being embedded in said vehicle. As a variant, the method may be implemented by any image-processing system outside a vehicle, for a camera mounted in a vehicle or outside a vehicle, for example on a walk-through scanner or an ATM.

Preferably, the method further comprises the steps of tracking the at least one person detected in a preceding image in a following image of the sequence of generated images, implementing the method on the following image, and fusing the 3D face model of the tracked person generated from the following image with the 3D face model of the tracked person generated in the preceding image. Tracking each person, and therefore each face, makes it possible to produce a succession of 3D models of each face, with a view to fusing them and further improving the authentication and/or identification.

Advantageously, the 3D model is generated using the 3D face-mask generation method Candide, which permits simple and detailed modeling.

In one embodiment, the method comprises, after detection of the face of at least one person in the rectified region of interest, an attempt to authenticate or identify the face, a model representing each detected face being generated and the subsequent steps being carried out only if the authentication or identification fails.

Preferably, the camera is a fish-eye camera allowing 360° images to be taken.

Another subject of the invention is a computer program product, characterized in that it comprises a set of program code instructions which, when they are executed by one or more processors, configure the one or more processors to implement a method such as presented above.

Another subject of the invention is an electronic control unit for a motor vehicle, said electronic control unit being configured to receive a sequence of images from a camera of the vehicle and, for each image of said sequence of images, to:
detect at least one person in said image,
define, in the image, at least one region called the “region of interest” for each detected person or group of detected persons,
for each identified region of interest:
rectify the region of interest,
detect the face of at least one person in the rectified region of interest,
generate a model representing each detected face,
rotate each generated model so that said face is visible straight on in the acquisition plane of the camera,
authenticate or identify the at least one person based on the at least one face having undergone rotation.

Preferably, the electronic control unit is further configured to:
track the at least one person detected in a preceding image in a following image of the sequence of generated images,
implement the method on the following image,
fuse the face model of the tracked person generated from the following image with the face model of the tracked person generated in the preceding image.

Advantageously, the electronic control unit is configured to generate the model produced using the 3D face-mask generation method Candide.

In one embodiment, the electronic control unit is configured, after detection of the face of at least one person in the rectified region of interest, to make an attempt to authenticate or identify the face, a model representing each detected face being generated and the subsequent steps being carried out only if the authentication or identification fails.

An aspect of the invention also relates to a motor vehicle comprising an electronic control unit such as presented above and at least one camera configured to generate a sequence of images and transmit it to said electronic control unit.

Preferably, the at least one camera is a fish-eye camera.

### BRIEF DESCRIPTION OF THE DRAWINGS

Other features and advantages of aspects of the invention will become more apparent upon reading the following description. It is purely illustrative and should be read with reference to the appended drawings, in which:

FIG. 1 schematically illustrates one embodiment of the system according to the invention.

FIG. 2 schematically illustrates one embodiment of the method according to the invention.

### DETAILED DESCRIPTION OF EXEMPLARY EMBODIMENTS

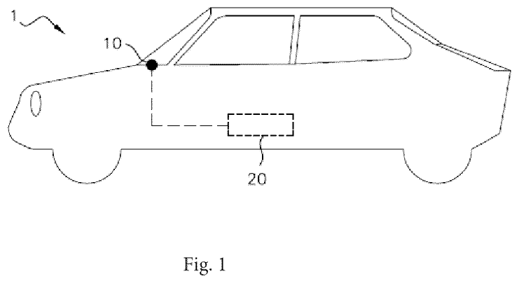

FIG. 1 illustrates one example of a motor vehicle 1 according to an aspect of the invention.

The vehicle 1 comprises a camera 10 and an electronic control unit 20.

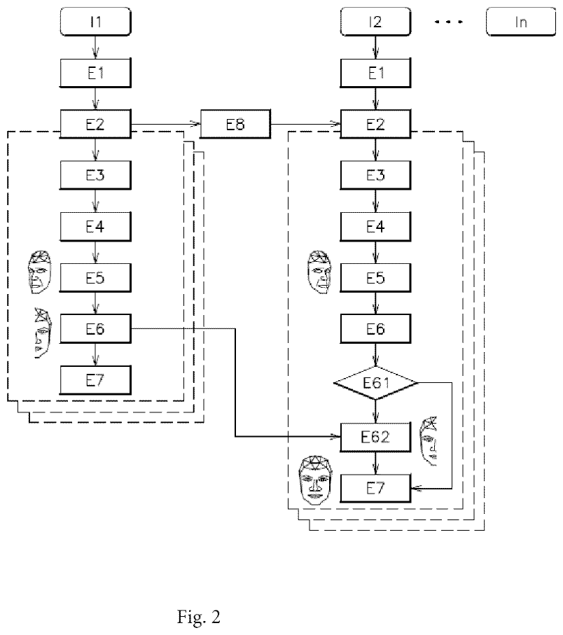

With reference to FIG. 2, the camera 10 is a fish-eye camera configured to generate a sequence of two-dimensional images I1, I2, . . . , In in a plane called the “acquisition” plane, and to transmit said sequence of images to the electronic control unit 20.

The electronic control unit 20 is configured to receive a sequence of images from the camera 10.

The electronic control unit 20 is configured, for each image of said sequence of images, to detect at least one person in said image, and to define, in the image, at least one region called the “region of interest” for each detected person or group of detected persons.

The electronic control unit 20 is configured, for each identified region of interest, to rectify said region of interest, to detect the face of at least one person in the rectified region of interest, to generate a model representing each detected face, to rotate each generated model so that said face is visible straight on in the acquisition plane of the camera, and to authenticate or identify the at least one person based on the at least one face having undergone rotation.

The electronic control unit 20 is configured to track the at least one person detected in a preceding image in a following image of the sequence of generated images, to implement the method on the following image, and to fuse the face model of the tracked person generated from the following image with the face model of the tracked person generated in the preceding image.

The electronic control unit 20 is configured to generate the model produced using the 3D face-mask generation method Candide.

The electronic control unit is configured, after detection of the face of at least one person in the rectified region of interest, to make an attempt to authenticate or identify the face, a 3D model representing each detected face being generated (also called reconstruction) and the subsequent steps being carried out only if the authentication or identification fails.

In terms of hardware, the electronic control unit comprises a processor capable of implementing a set of instructions allowing these various functions to be performed.

### Example of Implementation of an Aspect of the Invention

One example of implementation of the method will now be described with reference to FIG. 2.

To implement the method, the camera 10 generates a sequence of images and transmits it to the electronic control unit 20. For each image of the sequence of images, the electronic control unit 20 will carry out a plurality of processing steps.

First of all, the electronic control unit 20 detects one or more persons in the first image I1 in a step E1, then defines a region called the “region of interest” for each person or group of persons detected in a step E2. A group of persons corresponds to a plurality of people located in the same region of the image.

For each identified region of interest, in a step E3 the electronic control unit 20 rectifies the region of the first image I1 corresponding to said region of interest. Rectification is the process of applying geometric corrections to an image, in the present case to a segment of an image, based on information sampled from a source image (or raw image) depending on the geometric model selected. The raw image is then said to be rectified and the image synthesized is called the rectified image. Such a method is known per se and will not be described in more detail here.

In a step E4, the electronic control unit 20 then detects the face of at least one person in the rectified region of interest.

Once the detection has been carried out, the electronic control unit 20 may attempt to authenticate or identify the one or more detected faces.

If the authentication or identification fails, in a step E5 the electronic control unit 20 generates (or reconstructs) a 3D model representing each detected face. The 3D model is preferably generated using the 3D face-mask generation method Candide, which is known per se, or any other suitable method.

In a step E6, the electronic control unit 20 then rotates each generated 3D model so that said face is visible straight on in the acquisition plane of the camera 10.

In a step E7, the electronic control unit 20 then attempts to authenticate or identify the at least one person based on the at least one modelled face having undergone rotation.

If a person is not authenticated or identified in the first image I1, in a step E8 the electronic control unit 20 tracks, in the second image I2 of the sequence of generated images, the one or more persons detected in the first image, in a manner known per se, then implements steps E1 to E6 of the method described above on the second image I2 and steps E61 and E62 described below.

In a step E61, the electronic control unit 20 verifies whether the face detected in step E4 was tracked through step E8.

If so, the electronic control unit 20 fuses the 3D face model of the tracked person generated from the second image I2 and the 3D face model of the tracked person generated in the first image I1.

The electronic control unit 20 reiterates the method on each image of the sequence of images and fuses the successive models of each face until an authorized user of the vehicle 1 is authenticated or identified in a step E7, and then preferably activates a function of the vehicle such as, for example, a function unlocking the doors and trunk lid.

The identification may be achieved by comparing the 3D model of a face with an image of the face of an authorized user or a 3D model of the face of an authorized user recorded in a memory region of the electronic control unit 20.

In the event where no person is authenticated or identified, no function of the vehicle 1 is activated.

The invention makes it possible to rectify only one or more regions of interest of the image, in order to allow easy use of a 3D face model, which is rotated to face the camera and allow the authentication or identification.

1. A method, for a motor vehicle, for authenticating or identifying a person using a camera configured to generate two-dimensional images in an acquisition plane, said method comprising:
generating a sequence of images with the camera
for each image of said sequence of images:
detecting at least one person in said image,
defining in the image, at least one region called the “region of interest” for each detected person or group of detected persons,
for each identified region of interest:
rectifying the region of interest,
detecting the face of at least one person in the rectified region of interest,
generating a 3D model representing each detected face,
rotating each generated 3D model so that said face is visible straight on in the acquisition plane of the camera,
authenticating or identifying the at least one person based on the at least one face having undergone rotation, and, if a person is not authenticated or identified, carrying out the following steps:
tracking the at least one person detected in a preceding image in a following image of the sequence of generated images,
implementing the method described above on the following image,
fusing the 3D face model of the tracked person generated from the following image with the 3D face model of the tracked person generated in the preceding image.

2. The method as claimed in claim 1, wherein the 3D model is generated using the 3D face-mask generation method Candide.

3. The method as claimed in claim 1, comprising, after detection of the face of at least one person in the rectified region of interest, an attempt to authenticate or identify the face, a 3D model representing each detected face being generated and the subsequent steps being carried out only if the authentication or identification fails.

4. The method as claimed in claim 1, wherein the camera is a fish-eye camera.

5. A computer program product, comprising a set of program code instructions which, when they are executed by one or more processors, configure the one or more processors to implement a method as claimed in claim 1.

6. An electronic control unit for a motor vehicle, said electronic control unit being configured to receive a sequence of images from a camera of the vehicle and, for each image of said sequence of images, to:
detect at least one person in said image,
define, in the image, at least one region called the “region of interest” for each detected person or group of detected persons,
for each identified region of interest:
rectify the region of interest,
detect the face of at least one person in the rectified region of interest,
generate a 3D model representing each detected face,
rotate each generated 3D model so that said face is visible straight on in the acquisition plane of the camera,
authenticate or identify the at least one person based on the at least one face having undergone rotation, and, if a person is not authenticated or identified, the electronic control unit is further configured to:
track the at least one person detected in a preceding image in a following image of the sequence of generated images,
implement the method on the following image,
fuse the 3D face model of the tracked person generated from the following image with the 3D face model of the tracked person generated in the preceding image.

7. The electronic control unit as claimed in claim 6, configured to generate the 3D model produced using the 3D face-mask generation method Candide.

8. A motor vehicle comprising an electronic control unit as claimed in claim 6 and at least one camera configured to generate a sequence of images and transmit it to said electronic control unit.

9. A motor vehicle comprising an electronic control unit as claimed in claim 7 and at least one camera configured to generate a sequence of images and transmit it to said electronic control unit.
